(19) United States
(12) Patent Application Publication
(10) Pub. No.: US 2025/0265415 A1
(43) Pub. Date: Aug. 21, 2025

(54) COMPUTER SYSTEM AND METHOD OF SUPPORTING FAILURE INVESTIGATION FOR IT SYSTEM

(71) Applicant: Hitachi, Ltd., Tokyo (JP)

(72) Inventors: Mineyoshi MASUDA, Tokyo (JP); Takashi TAMESHIGE, Tokyo (JP); Taku WAKUI, Tokyo (JP)

(73) Assignee: Hitachi, Ltd., (omitted)

(21) Appl. No.: 18/885,243

(22) Filed: Sep. 13, 2024

(30) Foreign Application Priority Data
Feb. 20, 2024 (JP) 2024-023423

(51) Int. Cl. G06F 40/284; G06F 16/332; H04L 41/5022; H04L 41/5054

(52) U.S. Cl. CPC G06F 40/284; G06F 16/3329; H04L 41/5022; H04L 41/5054

(57) ABSTRACT

A computer system is coupled to an IT system formed of elements, and a text generation system. The computer system holds element information for managing observation data obtained from the IT system, relation information for managing relevance between the elements, and scope information that defines a scope representing a range of an investigation. The computer system selects the scope in a case where a failure has occurred in the IT system, identify at least one element to be investigated based on the relation information and the selected scope; obtain the observation data relating to the identified at least one element from the element information, generate a first prompt, which includes the viewpoint corresponding to the selected scope, the identified at least one element, and the obtained observation data, and which instructs to output findings relating to the failure in the IT system, and input the first prompt.

### CLAIM OF PRIORITY

The present application claims priority from Japanese patent application JP 2024-023423 filed on Feb. 20, 2024, the content of which is hereby incorporated by reference into this application.

### BACKGROUND OF THE INVENTION

This invention relates to a system for and a method of supporting a failure investigation for an IT system.

When an IT system which is formed of a plurality of elements and which executes a predetermined service stops or processing thereof is delayed due to a failure, an economic loss occurs. For that reason, an operation administrator is required to recover the IT system as soon as possible. In recovery work, a particularly time-consuming part is a failure investigation, and the operation administrator refers to a wide variety and a large amount of information to identify details and a cause of the failure. The information to which the operation administrator refers includes configuration information and observation data.

The configuration information is information for managing elements that form the IT system and relationships between the elements. The elements are called configuration items, and include, for example, hardware such as a server and a storage, software such as an OS, middleware, and an application, and services implemented by hardware and software. Each type of element has unique attributes. For example, the server has attributes such as CPU information, a memory capacity, and the number of power supplies. In the following, the elements that form the IT system are referred to as “CIs”. Information regarding relevance between the elements is information that indicates connections between the elements, such as a server and an OS running on the server.

The observation data includes event information, performance information, and logs in which events that have occurred in the CIs and states thereof were recorded. When an event relating to a failure occurs in a CI, the nature of the event is recorded as observation data.

In the failure investigation, the operation administrator narrows down the elements relating to an occurrence location of the failure by tracing the connections between the elements based on configuration information, and also identifies an impact range of the failure and a cause of the failure based on observation data.

In a case of generating programs and rules for achieving automation of failure investigations for the IT system, the number of variations is enormous, and hence development costs are extremely high.

### SUMMARY OF THE INVENTION

In recent years, a natural language processing technology has been attracting attention. In particular, a large language model (LLM), which can handle natural sentences, has been attracting attention as a technology that can replace human work.

The LLM is a natural language processing model constructed through use of a large amount of text data, and can execute various language processing tasks. The LLM receives a prompt including details of a task, such as questions described in a natural language, understands meanings of the details of the task, and generates and outputs text that serves as an answer. For example, when text including details of work and subject data is input to the LLM, details of the work using the data, results thereof, and the like can be obtained as the answer. The LLM performs processing after understanding a meaning of text, and hence the processing can be appropriately performed even when there are variations in the data and the text. Accordingly, through use of the LLM, it is possible to support the failure investigation for a general-purpose IT system.

Examples of related art that applies the natural language processing technology to troubleshooting include US 2022/0292415 A1. In US 2022/0292415 A1, there is disclosed a technology for creating a playbook for automating troubleshooting from past troubleshooting records written in natural sentences. However, the technology as described in US 2022/0292415 A1 provides the creation of a playbook for automating troubleshooting, and cannot be directly applied to the failure investigation.

An object of this invention is to provide a system for and a method of implementing a failure investigation for an IT system using an LLM.

A representative example of the present invention disclosed in this specification is as follows: a computer system comprises: a processor, a storage device coupled to the processor, and a network interface coupled to the processor. The computer system is coupled to an IT system formed of a plurality of elements and configured to execute a service, and a text generation system configured to generate answer text through use of a natural language processing model in accordance with a prompt that instructs execution of a language processing task. The computer system holds element information for managing observation data obtained from the IT system, relation information for managing relevance between the plurality of elements; and scope information that defines a scope representing a range of an investigation in a failure investigation for the IT system. The scope information stores data in which the scope and a viewpoint of analysis in the failure investigation for the IT system are associated with each other. The computer system is configured to: refer to the scope information to select the scope in a case where a failure has occurred in the IT system; identify at least one of the plurality of elements to be investigated based on the relation information and the selected scope; obtain the observation data relating to the identified at least one of the plurality of elements from the element information; generate a first prompt, which includes, as text, the viewpoint corresponding to the selected scope, the identified at least one of the plurality of elements, and the obtained observation data, and which instructs to output findings relating to the failure in the IT system, and input the first prompt to the text generation system; and obtain the answer text including the findings from the text generation system.

According to the at least one embodiment of this invention, it is possible to achieve a failure investigation for an IT system using a natural language processing model (LLM). Problems, configurations, and effects other than those described above become apparent from the following description of at least one embodiment.

### BRIEF DESCRIPTION OF THE DRAWINGS

The present invention can be appreciated by the description which follows in conjunction with the following figures, wherein:

FIG. 1 is a diagram for illustrating the outline of this invention;

FIG. 2 is a diagram for illustrating an example of a configuration of a system according to the first embodiment;

FIG. 3 is a diagram for illustrating an example of a hardware configuration of a management computer in the first embodiment;

FIG. 4 is a table for showing an example of a data structure of the LLM service information in the first embodiment;

FIG. 5 is a table for showing an example of a data structure of the user information in the first embodiment;

FIG. 6 is a table for showing an example of a data structure of the CI information in the first embodiment;

FIG. 7 is a table for showing an example of a data structure of the CI relation information in the first embodiment;

FIG. 8 is a table for showing an example of a data structure of the scope information in the first embodiment;

FIG. 9 is a table for showing an example of a data structure of the role order information in the first embodiment;

FIG. 10 is a table for showing an example of a data structure of the observation data conversion method information in the first embodiment;

FIG. 11 is a table for showing an example of a data structure of the investigation result information in the first embodiment;

FIG. 12 is a table for showing an example of a data structure of the user operation history information in the first embodiment;

FIG. 13 is a flow chart for illustrating an example of failure investigation processing to be executed by the management computer in the first embodiment;

FIG. 14 is a flow chart for illustrating an example of the common data generation processing to be executed by the management computer in the first embodiment;

FIG. 15 is a flow chart for illustrating an example of the role order determination processing to be executed by the management computer in the first embodiment;

FIG. 16 is a flow chart for illustrating an example of individual failure investigation processing to be executed by the management computer in the first embodiment;

FIG. 17 is a flow chart for illustrating an example of the observation data text generation processing to be executed by the management computer in the first embodiment;

FIG. 18 is a flow chart for illustrating an example of the findings data generation processing to be executed by the management computer in the first embodiment;

FIG. 19 is a flow chart for illustrating an example of information presentation processing to be executed by the management computer in the first embodiment;

FIG. 20 is a view for illustrating an example of a screen presented by the management computer in the first embodiment; and

FIG. 21 is a flow chart for illustrating an example of feedback processing to be executed by the management computer in the first embodiment.

### DETAILED DESCRIPTION OF THE PREFERRED EMBODIMENTS

Now, description is given of at least one embodiment of this invention referring to the drawings. It should be noted that this invention is not to be construed by limiting the invention to the content described in the following at least one embodiment. A person skilled in the art would easily recognize that specific configurations described in the following at least one embodiment may be changed within the scope of the concept and the gist of this invention.

In configurations of the at least one embodiment of this invention described below, the same or similar components or functions are denoted by the same reference numerals, and a redundant description thereof is omitted here.

Notations of, for example, “first”, “second”, and “third” herein are assigned to distinguish between components, and do not necessarily limit the number or order of those components.

### First Embodiment

In general, a failure is investigated by a team. The team is formed of members having various roles, and in order to increase efficiency in investigation, each of the members is responsible for his or her role to cooperate with the other members to conduct an investigation. Examples of the role include an incident commander, a person in charge of an investigation, and a person in charge of a service desk.

The member assigned as an incident commander is responsible for troubleshooting, and performs tasks such as creating a plan for troubleshooting, allocating work to each member, and making regular reports to relevant departments. The members assigned as persons in charge of an investigation receive instructions from the incident commander to investigate parts of a system, for example, a range relating to a database including a storage, a range of applications including an OS or middleware, and an overall network, within their respective ranges of responsibility. The member assigned as a person in charge of a service desk answers inquiries from users of an IT system about a status of the IT system, an expected recovery time, and other information that is currently known.

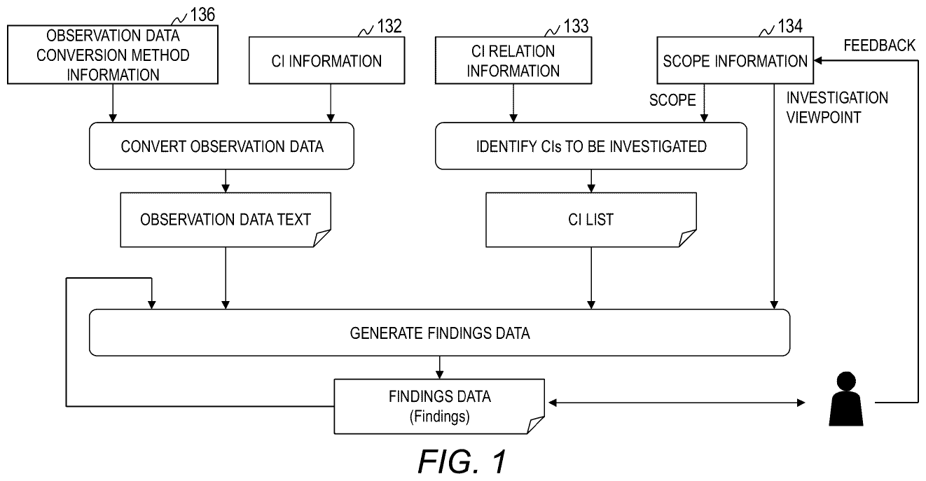

An outline of this invention is described. FIG. 1 is a diagram for illustrating the outline of this invention. First, information to be used in this invention is described.

CI information 132 and CI relation information 133 are information that is generally held in operation management of an IT system. The CI information 132 stores attributes and observation data (attribute values) of CIs that form the IT system. The CI relation information 133 stores data for managing relationships between the CIs.

Scope information 134 and observation data conversion method information 136 are characteristic information of this invention. The scope information 134 stores data in which a role, a scope being the range of an investigation, and a viewpoint of a failure investigation are associated with each other. The scope and the viewpoint of a failure investigation are described in a natural language, which is much easier to be described than rules and programs for a failure investigation. The observation data conversion method information 136 is information for managing a method for converting the observation data into text that can be interpreted by an LLM. The LLM may be used to convert the observation data. In this case, it is not required to develop a conversion algorithm.

A failure investigation support program 120 performs a failure investigation in the following procedure.

First, the failure investigation support program 120 refers to a CI relation based on the scope defined in the scope information 134 to identify CIs to be investigated.

Subsequently, the failure investigation support program 120 refers to the observation data conversion method information 136 to convert the observation data of the identified CIs into observation data text that can be interpreted by the LLM.

Subsequently, the failure investigation support program 120 generates a prompt including a list of the identified CIs, the observation data text, and the viewpoint defined in the scope information 134. The viewpoint represents a policy of analysis in the failure investigation, which is the task to be executed by the LLM. In a first embodiment of this invention, a prompt that instructs analysis of the observation data based on an investigation viewpoint and generation of findings data (Findings) including results of the analysis is generated. The failure investigation support program 120 inputs the prompt to the LLM to obtain the findings data from the LLM. The findings data of another failure investigation may be included in the prompt.

The failure investigation support program 120 presents the findings data to the members who are investigating the failure. The members refer to the findings data to, for example, identify the cause of the failure.

According to the first embodiment of this invention, it is possible to automatically achieve various IT system failure investigations while suppressing development costs.

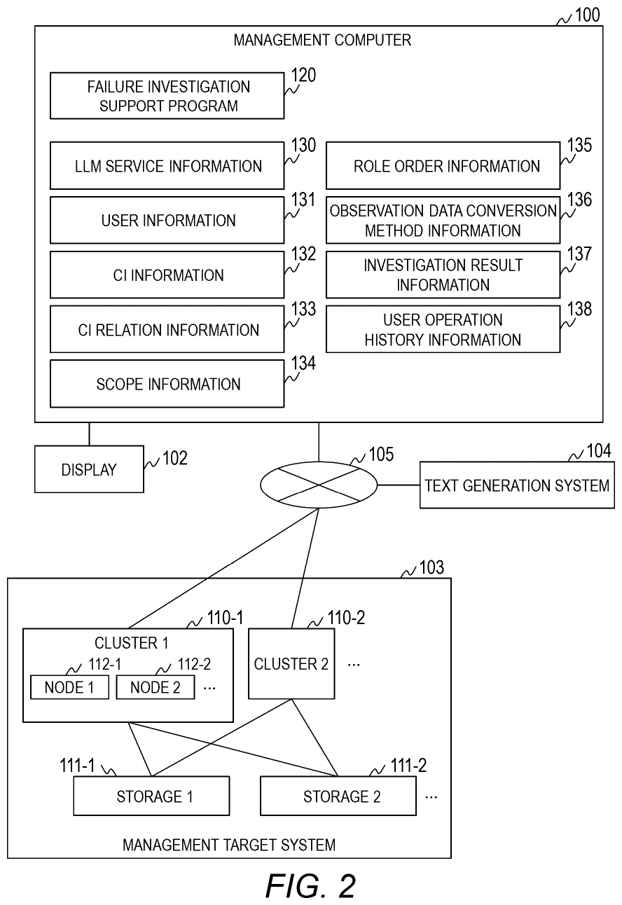

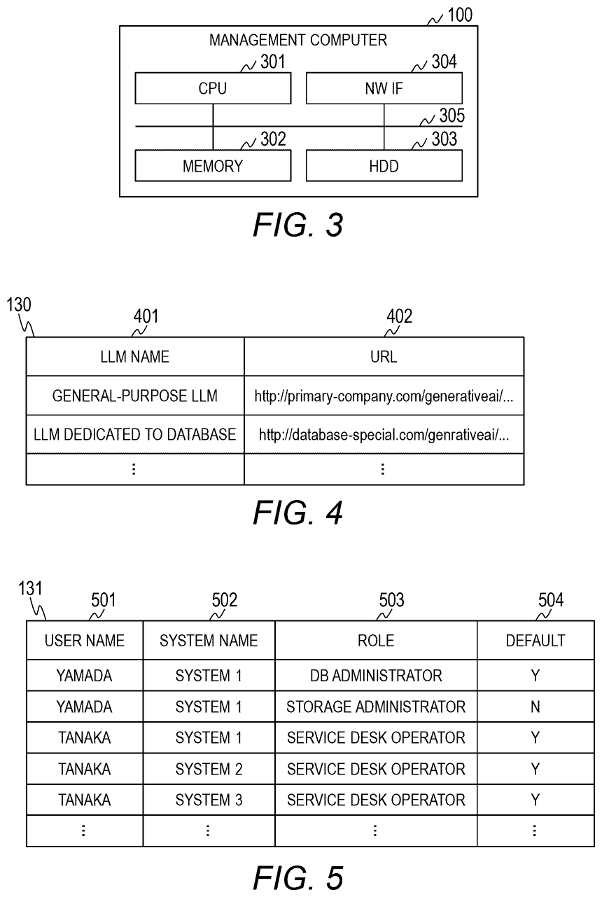

FIG. 2 is a diagram for illustrating an example of a configuration of a system according to the first embodiment. FIG. 3 is a diagram for illustrating an example of a hardware configuration of a management computer 100 in the first embodiment.

The system includes the management computer 100, a management target system 103, and a text generation system 104. The management computer 100, the management target system 103, and the text generation system 104 are coupled to each other through a network 105 such as a LAN.

The management target system 103 is a system on which an IT system runs. The management target system 103 includes a cluster 110 formed of a plurality of nodes (computers) 112, and storages 111. Although not shown, one or more IT systems run in one cluster 110. In the first embodiment, it is assumed that the management computer 100 is coupled to the cluster 110 so as to enable communication therebetween. The cluster 110 can allocate volumes provided by the storages 111 to the nodes 112. Data of the IT system is stored in the volumes.

The configuration of the management target system 103 on which the IT system runs is merely an example and is not limited thereto. For example, the node 112 may be a virtual machine. The IT system may also run on a cloud system.

The text generation system 104 is a system that provides a service using the LLM. The management computer 100 may hold the LLM. The management computer 100 may also be coupled to a plurality of text generation systems 104.

The management computer 100 supports the failure investigation for the IT system. As illustrated in FIG. 3, the management computer 100 includes a CPU 301, a memory 302, an HDD 303, and a network interface 304. The respective hardware elements are coupled to each other through a bus 305. In addition, a display 102 is coupled to the management computer 100. Input devices (not shown) such as a keyboard and a mouse are coupled to the management computer 100.

The HDD 303 of the management computer 100 stores the failure investigation support program 120, LLM service information 130, user information 131, the CI information 132, the CI relation information 133, the scope information 134, role order information 135, the observation data conversion method information 136, investigation result information 137, and user operation history information 138. The CPU 301 loads the failure investigation support program 120 into the memory 302 and executes the failure investigation support program 120. The CPU 301 loads various kinds of information into the memory 302 as the requirement arises.

FIG. 4 is a table for showing an example of a data structure of the LLM service information 130 in the first embodiment.

The LLM service information 130 stores information regarding available LLMs. The LLM service information 130 stores entries each including an LLM name 401 and a URL 402. There is one entry for one LLM.

The LLM name 401 is a field that stores a name of an LLM. The URL 402 is a field that stores a URL for accessing the text generation system 104 that provides a service using the LLM. The management computer 100 can use the LLM by accessing the text generation system 104 based on the URL.

FIG. 5 is a table for showing an example of a data structure of the user information 131 in the first embodiment.

The user information 131 stores information regarding a role of a user (member) who is an administrator of an IT system. The user information 131 stores entries each including a user name 501, a system name 502, a role 503, and a default 504. There is one entry for a pair of a user and a role.

The user name 501 is a field that stores a user name. The system name 502 is a field that stores a name of the IT system for which the user has administrative authority. The role 503 is a field that stores the role assigned to the user.

The default 504 is a field that stores information indicating whether the role corresponding to the entry is a default role of the user. When the role corresponding to the entry is the default role of the user, “Y” is stored, and when the role corresponding to the entry is not the default role of the user, “N” is stored.

A single user may be assigned a plurality of roles. A single user may also manage a plurality of IT systems.

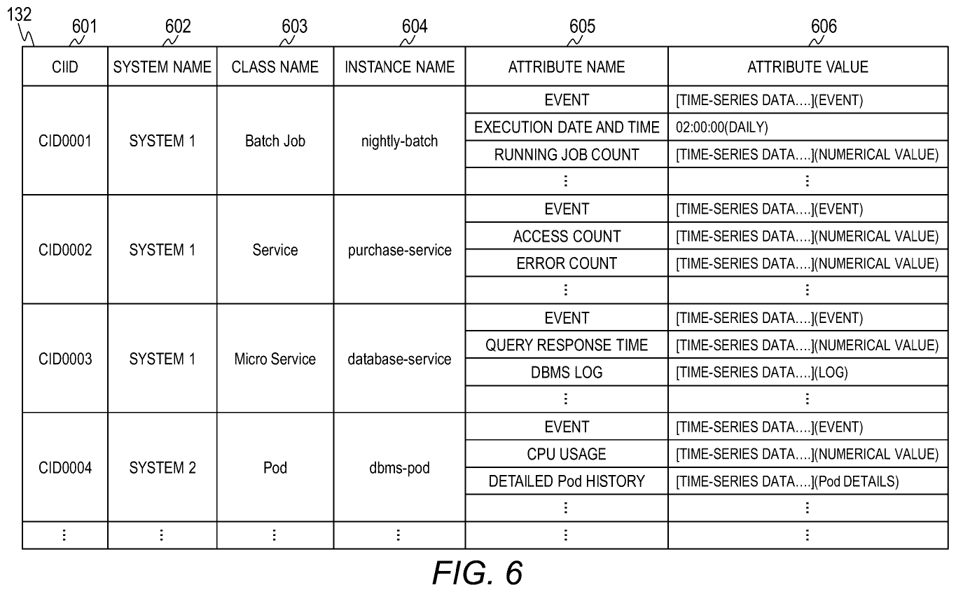

FIG. 6 is a table for showing an example of a data structure of the CI information 132 in the first embodiment.

The CI information 132 stores information regarding CIs that form an IT system. Examples of the CIs include not only computing resources such as physical servers and virtual servers but also services provided by the IT system, microservices that form the services, pods and clusters that are operating entities of the microservices, and nodes that form the clusters.

The CI information 132 stores entries each including a CI ID 601, a system name 602, a class name 603, an instance name 604, an attribute name 605, and an attribute value 606. There is one entry for a pair of an IT system and a CI.

The CI ID 601 is a field that stores an identifier of a CI. The system name 602 is a field that stores the name of an IT system that includes the CI. The class name 603 is a field that stores a type of CI. The instance name 604 is a field that stores a name of the CI. The attribute name 605 is a field that stores a name of an attribute that can be obtained from the CI. The attribute value 606 is a field that stores a value (observation data) of the attribute obtained from the CI.

Examples of the attribute value of the CI include a type of event of a batch job or the like, an execution date and time thereof, and a performance value. The attribute values are obtained by a monitoring program that monitors the IT system, and are stored in the attribute value 606 as time-series data including the time and the attribute value. The symbols “( )” in the attribute value 606 in FIG. 6 indicates a data type. The observation data may be managed as separate information.

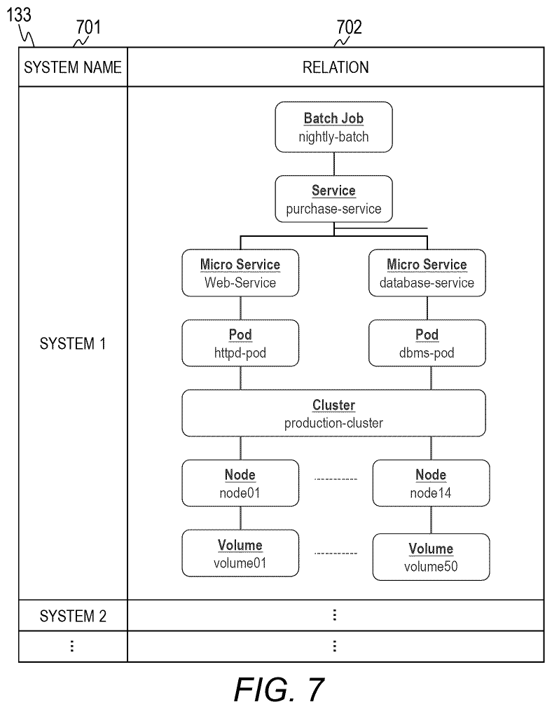

FIG. 7 is a table for showing an example of a data structure of the CI relation information 133 in the first embodiment.

The CI relation information 133 stores information regarding logical coupling relationships between CIs. The CI relation information 133 stores entries each including a system name 701 and a relation 702. There is one entry for one IT system.

The system name 701 is a field that stores the name of an IT system. The relation 702 is a field that stores data indicating the logical coupling relationships between the CIs that form the IT system. In FIG. 7, the relation is expressed as a graph, but in actuality, information on each pair of CIs having a coupling relationship is stored. An attribute value of each coupling relationship between the CIs may be stored. For example, in a case of a pair of CIs that are coupled by a physical wire, it is conceivable that a link speed is stored as the attribute value.

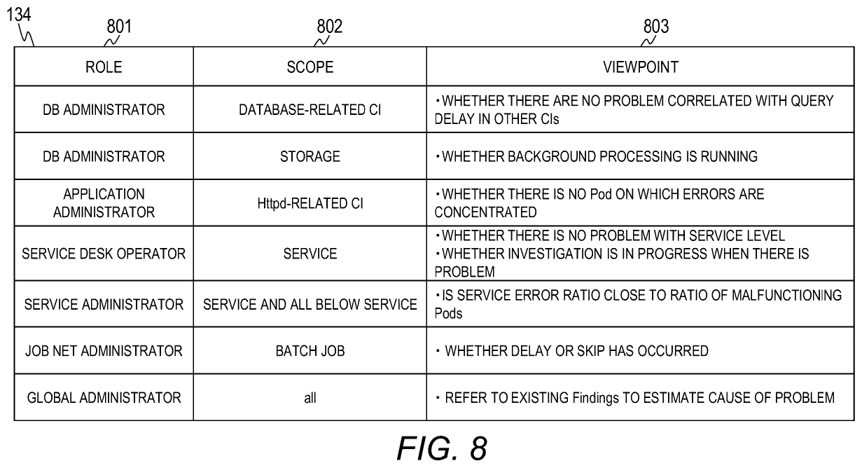

FIG. 8 is a table for showing an example of a data structure of the scope information 134 in the first embodiment.

The scope information 134 stores information regarding a range (scope) and a viewpoint of a failure. The scope information 134 stores entries each including a role 801, a scope 802, and a viewpoint 803. There is one entry for a pair of a role and a scope.

The role 801 is a field that stores the role. The scope 802 is a field that stores information that defines the range of an investigation. The viewpoint 803 is a field that stores the viewpoint of a failure investigation (task).

The information that defines the range of CIs to be investigated may be, for example, a rule describing the type of CI or a natural sentence describing characteristics of the CIs and others. When a rule is set in the scope 802, the failure investigation support program 120 identifies the CIs to be investigated by executing internal processing. When a natural language is set in the scope 802, the failure investigation support program 120 uses the LLM to identify the CIs to be investigated. The viewpoint 803 stores a natural sentence that expresses the viewpoint of a failure investigation.

The following information may be considered as the information that defines the range of the CIs to be investigated.

### (Example 1) Among CIs Having a CI Class of a Service, CIs that are Databases and CIs that can be Reached by Tracing the Relation in a Downward Direction from the Same CI

### (Example 2) CIs Relating to Databases

In the first embodiment, the scope and the viewpoint are set for the role, but this invention is not limited thereto. When the role is not particularly set, the data may be obtained by associating the viewpoint with the scope.

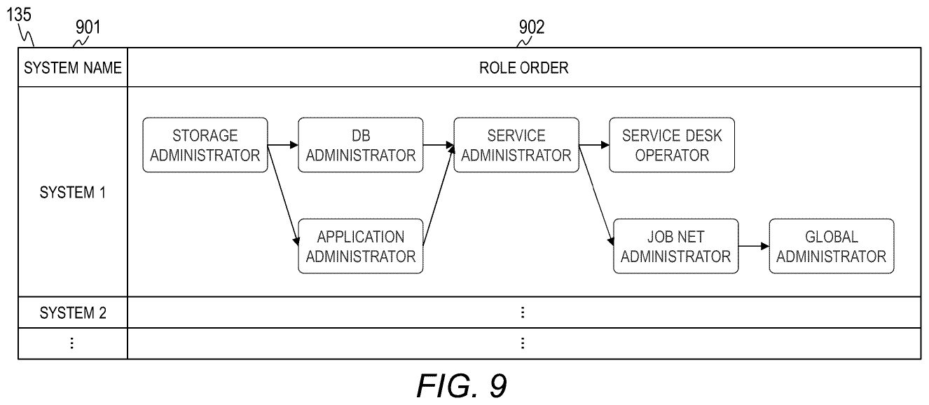

FIG. 9 is a table for showing an example of a data structure of the role order information 135 in the first embodiment.

The role order information 135 stores information regarding the order of roles for performing a failure investigation. The role order information 135 stores entries each including a system name 901 and a role order 902. There is one entry for one IT system.

The system name 901 is a field that stores the name of an IT system. The role order 902 is a field that stores information that defines the order of the roles for performing the failure investigation. In FIG. 9, the role order is expressed as a directed graph. This directed graph indicates that the failure investigation is performed with the role corresponding to a source before the role corresponding to a destination.

It is not required to define the role order for each IT system. For example, a common role order may be defined for the IT systems.

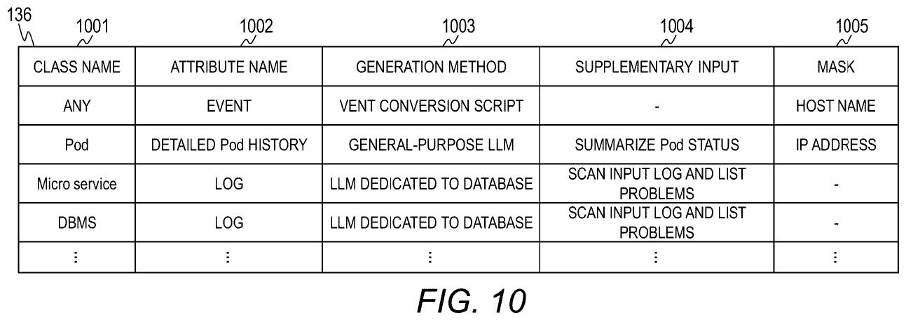

FIG. 10 is a table for showing an example of a data structure of the observation data conversion method information 136 in the first embodiment.

The observation data conversion method information 136 stores information regarding a method of converting the observation data into text. The observation data conversion method information 136 stores entries each including a class name 1001, an attribute name 1002, a generation method 1003, a supplementary input 1004, and a mask 1005. There is one entry for each pair of a class name and an attribute name.

The class name 1001 is a field that stores the type of CI. The value “ANY” indicates all types of CI. The attribute name 1002 is a field that stores the name of an attribute that can be obtained from a CI.

The generation method 1003 is a field that stores information regarding the method of converting the observation data into text. The generation method 1003 stores a script or an LLM type. The supplementary input 1004 is a field that stores instruction details to be given to the LLM when the LLM is used to generate observation data text. The mask 1005 is a field that stores the attribute value to be concealed when the LLM is used to generate observation data text. It is possible to generate text of the observation data while ensuring security by concealing the attribute value.

An event conversion script for converting the observation data relating to an event into text is stored in the generation method 1003 of the first entry of FIG. 10. The event conversion script converts the attribute value included in the observation data into a character string.

A type of LLM to be used is stored in the generation method 1003 of the second entry of FIG. 10. In this case, the failure investigation support program 120 inputs a prompt that instructs to give a summary of a Pod status, which includes detailed information on a Pod in Kubernetes (detailed information on the Pod obtained through use of an API or a command), to a general-purpose LLM to obtain text containing the summary of the Pod status.

Use of the LLM for generating text of the observation data can reduce development costs of algorithms for generating text from the observation data.

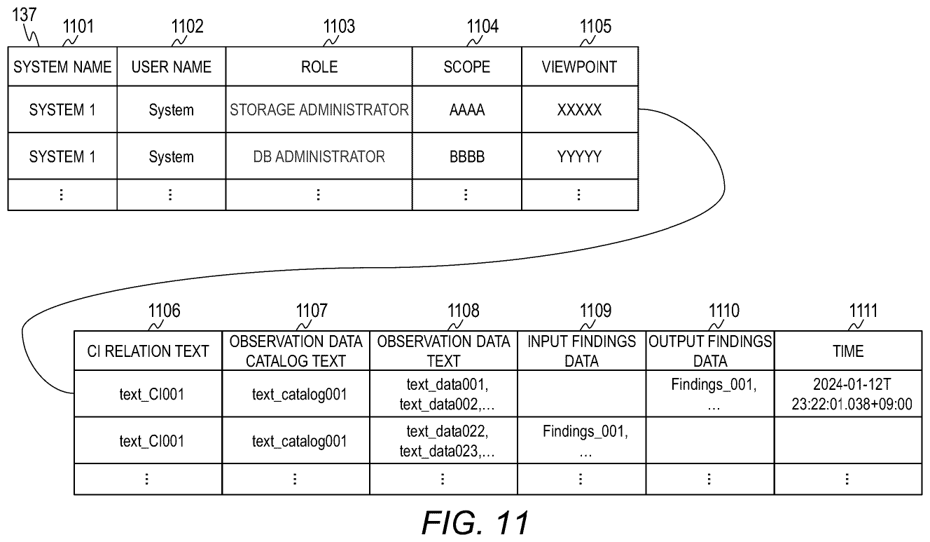

FIG. 11 is a table for showing an example of a data structure of the investigation result information 137 in the first embodiment.

The investigation result information 137 is information for managing progress and results of a failure investigation. The investigation result information 137 stores entries each including a system name 1101, a user name 1102, a role 1103, a scope 1104, a viewpoint 1105, CI relation text 1106, observation data catalog text 1107, observation data text 1108, input findings data 1109, output findings data 1110, and a time 1111.

The system name 1101 is a field that stores the name of an IT system that performed the failure investigation. The user name 1102 is a field that stores the name of a user who performed the failure investigation. The value “System” means that the failure investigation support program 120 performed the failure investigation.

The role 1103 is a field that stores the role. The scope 1104 is a field that stores the scope. The viewpoint 1105 is a field that stores the viewpoint.

The CI relation text 1106 is a field that stores the text of the relation of the CIs. The observation data catalog text 1107 is a field that stores the text of a catalog of the observation data (attribute values) of the CIs to be investigated. The observation data text 1108 is a field that stores the text of the observation data.

The input findings data 1109 is a field that stores findings data to be included in the prompt. The output findings data 1110 is a field that stores findings data obtained from the LLM. The time 1111 is a field that stores a time at which the findings data was obtained from the LLM.

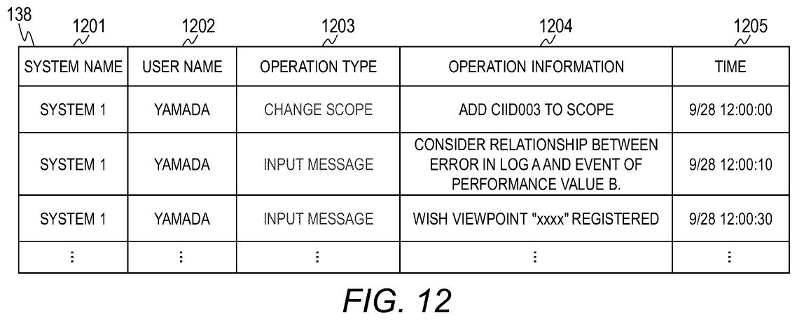

FIG. 12 is a table for showing an example of a data structure of the user operation history information 138 in the first embodiment.

The user operation history information 138 stores user input information. The user operation history information 138 stores entries each including a system name 1201, a user name 1202, an operation type 1203, operation information 1204, and a time 1205. There is one entry for each operation performed by the user.

The system name 1201 is a field that stores the name of an IT system under investigation. The user name 1202 is a field that stores the name of a user who performed an operation. The operation type 1203 is a field that stores a type of operation. The operation information 1204 is a field that stores details of the operation information. The time 1205 is a field that stores a time at which the operation was performed.

Now, processing to be executed by the management computer 100 is described.

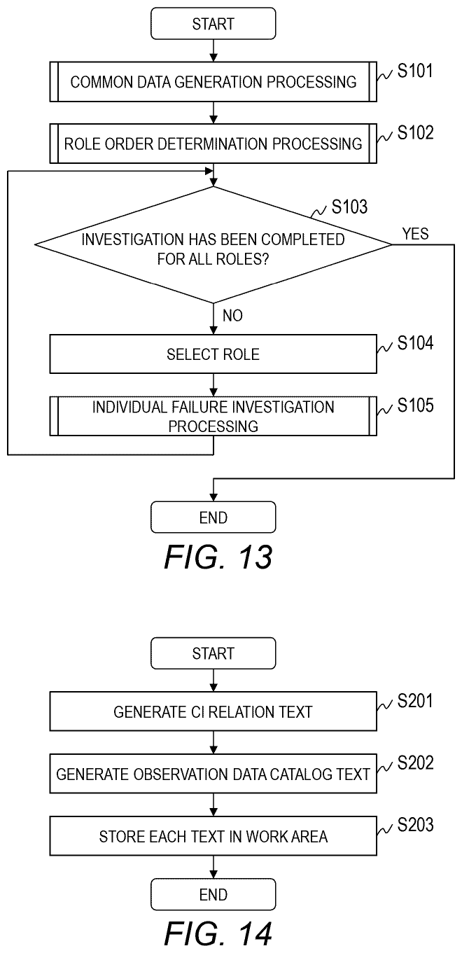

FIG. 13 is a flow chart for illustrating an example of failure investigation processing to be executed by the management computer 100 in the first embodiment. In the failure investigation processing, the failure investigation support program 120 obtains matters, that is, findings, relating to the failure in the IT system under investigation.

The management computer 100 starts the failure investigation processing when an execution instruction is received from a user, when there is a call from an API published to the outside, or when a specific event occurs. At this time, the name of the IT system under investigation is input to the management computer 100. The specific event is, for example, an event corresponding to a failure or an event indicating deterioration in service level, such as an increase in error rate of a request or an increase in response time of a request.

The failure investigation support program 120 executes common data generation processing for generating common data for the IT system under investigation (S101). The common data includes data relating to the configuration of the IT system and the catalog of the observation data that can be obtained from the CI. The common data generation processing is described later in detail. The IT system under investigation is hereinafter referred to as “target IT system”.

Subsequently, the failure investigation support program 120 executes role order determination processing (S102). The role order determination processing is described later in detail.

Subsequently, the failure investigation support program 120 determines whether or not the processing has been completed for all roles (S103).

When it is determined that the processing has not been completed for all roles, the failure investigation support program 120 selects one role from among the unprocessed roles (S104).

Subsequently, the failure investigation support program 120 executes individual failure investigation processing based on the selected role (S105). After that, the failure investigation support program 120 returns to S103.

When it is determined in S103 that the processing has been completed for all the roles, the failure investigation support program 120 ends the failure investigation processing.

FIG. 14 is a flow chart for illustrating an example of the common data generation processing to be executed by the management computer 100 in the first embodiment. In the common data generation processing, the name of the IT system is passed as an argument.

The failure investigation support program 120 generates CI relation text (S201). Specifically, the following processing is executed.

(S201-1) The failure investigation support program 120 refers to the CI relation information 133 to obtain information stored in the relation 702 of the entry corresponding to the target IT system. The failure investigation support program 120 also refers to the CI information 132 to obtain information stored in the entry corresponding to the target IT system.

(S201-2) The failure investigation support program 120 generates CI relation text based on the obtained information. For example, the CI relation text is generated by the following method.

(Procedural Step 1) The failure investigation support program 120 generates text representing each CI that forms the target IT system based on the information obtained from the CI information 132. For example, the text (character string) “CIID001: Batch Job: nightly-batch” is generated from the first entry of FIG. 6.

(Procedural Step 2) The failure investigation support program 120 generates text that expresses the coupling relationships between CIs that have coupling relationships as a tree structure based on the information obtained from the CI relation information 133. The coupling between CIs can be expressed by indentation. For example, in a case of the CI relation shown in FIG. 7, the following text is generated.

```
CIID001:Batch Job:nightly-batch
- CIID002:Service:purchase-service
  - CIID003:Micro Service:Web-Service
    - CIID005:Pod:httpd-pod
      - CIID006:Cluster:production-cluster
        - CIID007:Node:node01
          (the rest omitted)
  - CIID004:Micro Service:database-service
      - CIID006:Cluster:production-cluster (already mentioned)
```

As another method of describing the CI relation, the CI relation may be described by arranging a parent CI and a child CI of each relationship side by side as shown below.

CIID001: Batch Job: nightly-batch-CIID002: Service: purchase-service

The processing step of Step S201 has been described above. Subsequently, the failure investigation support program 120 generates observation data catalog text (S202).

Specifically, the failure investigation support program 120 generates observation data catalog text based on the attribute name 605 of the entry obtained from the CI information 132.

For example, for the CI of the first entry of FIG. 6, the following text is written in the observation data catalog text. In this case, only the attribute for which the attribute value of the CI is time-series data is extracted.

CIID001: Batch Job: nightly-batch
event
running job count

Subsequently, the failure investigation support program 120 stores the CI relation text and the observation data catalog text in a work area of the memory 302 (S203), and then ends the common data generation processing.

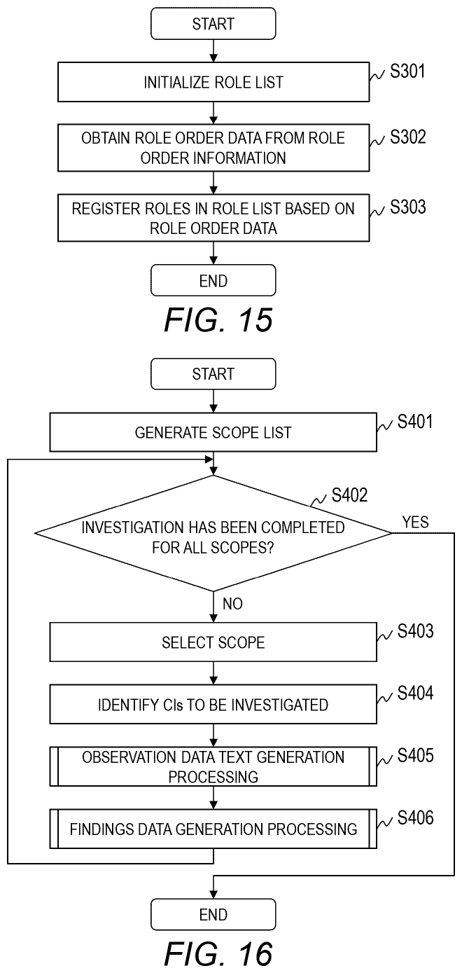

FIG. 15 is a flow chart for illustrating an example of the role order determination processing to be executed by the management computer 100 in the first embodiment. In the role order determination processing, the name of the IT system is passed as an argument.

The failure investigation support program 120 initializes a role list (S301). In other words, an empty role list is generated.

The failure investigation support program 120 obtains role order data (directed graph) of the target IT system from the role order information 135 (S302).

The failure investigation support program 120 registers the roles in the role list based on the role order data (S303), and then ends the role order determination processing.

Specifically, the failure investigation support program 120 scans edges of the directed graph starting from the root node of the directed graph, and registers roles corresponding to the nodes in the role list in order of scanning.

FIG. 16 is a flow chart for illustrating an example of individual failure investigation processing to be executed by the management computer 100 in the first embodiment. In the individual failure investigation processing, the name and the role of the IT system are passed as arguments.

The failure investigation support program 120 generates a scope list (S401).

Specifically, the failure investigation support program 120 refers to the scope information 134 to search for an entry in which the selected role is stored in the role 801. The failure investigation support program 120 registers the scope 802 of the retrieved entry in the scope list.

The failure investigation support program 120 determines whether or not the processing has been completed for all the scopes of the selected role (S402). When it is determined that the processing has been completed for all the scopes of the selected role, the failure investigation support program 120 ends the individual failure investigation processing.

When it is determined that the processing has not been completed for all the scopes of the selected role, the failure investigation support program 120 selects one scope from the scope list (S403).

At this time, the failure investigation support program 120 deletes the selected scope from the scope list. The failure investigation support program 120 also updates the investigation result information 137. Specifically, the failure investigation support program 120 adds an entry to the investigation result information 137, sets the name of the target IT system in the system name 1101, sets “System” in the user name 1102, sets the role selected in S104 in the role 1103, and sets the selected scope in the scope 1104. In addition, the failure investigation support program 120 sets the CI relation text and the observation data catalog text generated in the common data generation processing in the CI relation text 1106 and the observation data catalog text 1107 of the added entry.

The failure investigation support program 120 identifies CIs to be investigated from among the CIs of the target IT system based on the selected scope (S404). There are two possible identification methods as follows.

(Method 1) The failure investigation support program 120 uses the LLM to identify CIs to be investigated. Specifically, the failure investigation support program 120 generates a prompt including the CI relation text generated in the common data generation processing, text corresponding to the scope, and an instruction statement that instructs extraction of CIs to be investigated based on the scope, and inputs the prompt to the LLM to obtain a list of the CIs to be investigated.

(Method 2) The failure investigation support program 120 identifies the CIs to be investigated based on rules. For example, when the scope is “Service”, the failure investigation support program 120 extracts CIs each having the value “Service” in the class name or the instance name. In addition, when tags can be added to a CI, the scopes are defined as a list of tags, and the failure investigation support program 120 extracts CIs having a corresponding tag.

Subsequently, the failure investigation support program 120 executes observation data text generation processing (S405). The observation data text generation processing is described later in detail.

Subsequently, the failure investigation support program 120 executes findings data generation processing (S406), and then returns to S402. The findings data generation processing is described later in detail.

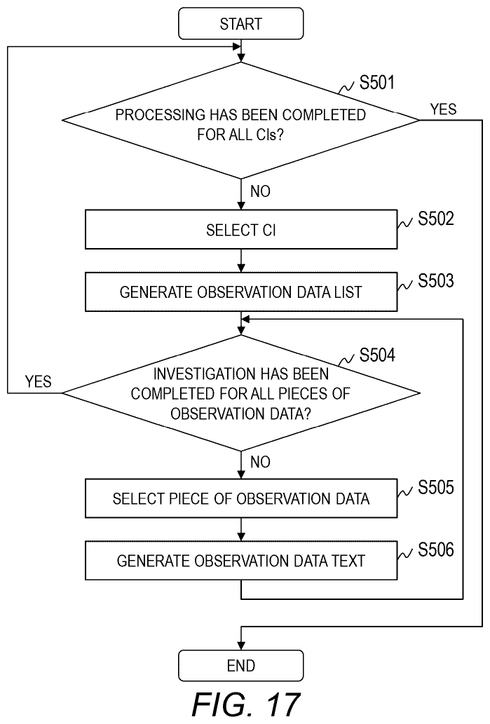

FIG. 17 is a flow chart for illustrating an example of the observation data text generation processing to be executed by the management computer 100 in the first embodiment. In the observation data text generation processing, the name of the IT system is passed as an argument.

The failure investigation support program 120 determines whether or not the processing has been completed for all the CIs to be investigated (S501). When it is determined that the processing has been completed for all the CIs to be investigated, the failure investigation support program 120 ends the observation data text generation processing.

When it is determined that the processing has not been completed for all the CIs to be investigated, the failure investigation support program 120 selects one CI from among the CIs to be investigated (S502).

Subsequently, the failure investigation support program 120 generates an observation data list for the selected CI (S503).

Specifically, the failure investigation support program 120 refers to the CI information 132 to generate an observation data list based on the attribute name 605 of the entry corresponding to the selected CI. The failure investigation support program 120 may generate the observation data list based on the observation data catalog text.

Subsequently, the failure investigation support program 120 determines whether or not the processing has been completed for all pieces of observation data (S504). When it is determined that the processing has been completed for all the pieces of observation data, the failure investigation support program 120 returns to S501.

When it is determined that the processing has not been completed for all the pieces of observation data, the failure investigation support program 120 selects one piece of observation data from the observation data list (S505). At this time, the failure investigation support program 120 deletes the selected piece of observation data from the observation data list.

Subsequently, the failure investigation support program 120 generates observation data text for the selected piece of observation data (S506), and then returns to S504. Specifically, the following processing is executed.

(S506-1) The failure investigation support program 120 refers to the observation data conversion method information 136 to search for an entry having the class name 1001 matching the class name of the selected CI and having the attribute name 1002 matching the attribute name of the selected observation data.

(S506-2) The failure investigation support program 120 refers to the CI information 132 to obtain the attribute value 606 of a row in which the attribute name 605 of the entry corresponding to the selected CI matches the selected observation data.

(S506-3) The failure investigation support program 120 converts the obtained observation data into text based on an identified observation data conversion method. In a case of a conversion method using an LLM, the failure investigation support program 120 generates a prompt including the observation data or data obtained by statistically processing the observation data (such as average value, maximum value, or previous-day or week average value) and instruction details, and inputs the generated prompt to the LLM to obtain the observation data text.

(S506-4) The failure investigation support program 120 sets the generated observation data text to the observation data text 1108 of the entry added to the investigation result information 137 in S403.

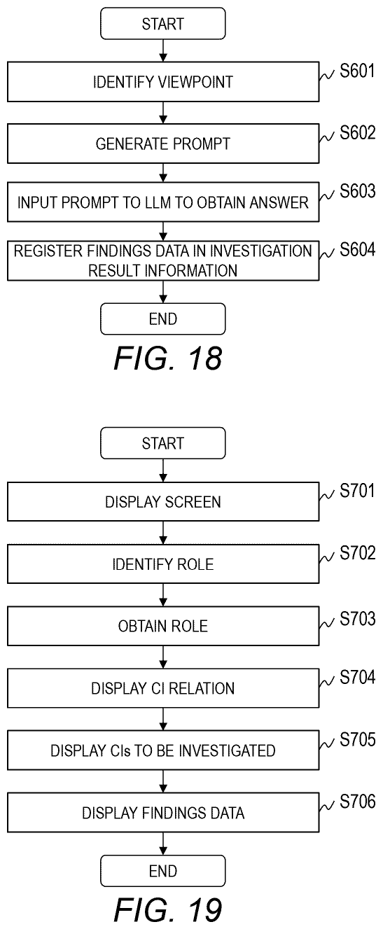

FIG. 18 is a flow chart for illustrating an example of the findings data generation processing to be executed by the management computer 100 in the first embodiment. In the findings data generation processing, the name of the IT system, the role, and the scope are passed as arguments.

The failure investigation support program 120 identifies a viewpoint corresponding to a pair of a role and a scope (S601).

Specifically, the failure investigation support program 120 refers to the scope information 134 to search for an entry having a pair of values of the role 801 and the scope 802 matching the selected pair of the role and the scope. The failure investigation support program 120 obtains the viewpoint 803 of the retrieved entry, and sets the obtained viewpoint 803 as the viewpoint 1105 of the entry added to the investigation result information 137 in S403.

Subsequently, the failure investigation support program 120 generates a prompt (S602). Specifically, the following processing is executed.

(S602-1) The failure investigation support program 120 obtains the entry added to the investigation result information 137 in S403. The failure investigation support program 120 may refer to the investigation result information 137 to obtain the findings data obtained by the individual failure investigation processing for the same IT system.

(S602-2) The failure investigation support program 120 generates a prompt including the CI relation text and the observation data text and having the viewpoint as the policy of the analysis. In the first embodiment, a prompt that instructs to output the findings of each CI is generated. For example, a method of generating, for each CI, a prompt including the CI relation text and the observation data text for the observation data relating to the CI is conceivable. Further, a method of generating a prompt including the output of the findings for each CI as a task instruction is conceivable.

When the findings data has been obtained in S602-1, the findings data may be included in the prompt. At this time, the failure investigation support program 120 sets the findings data in the input findings data 1109 of the entry added to the investigation result information 137 in S403.

Subsequently, the failure investigation support program 120 inputs the generated prompt to the LLM to obtain the answer (text) from the LLM (S603).

Subsequently, the failure investigation support program 120 registers the obtained answer as the findings data in the investigation result information 137 (S604).

Specifically, the failure investigation support program 120 sets the answer in the output findings data 1110 of the entry added to the investigation result information 137 in S403, and also sets a time at which the answer was obtained in the time 1111.

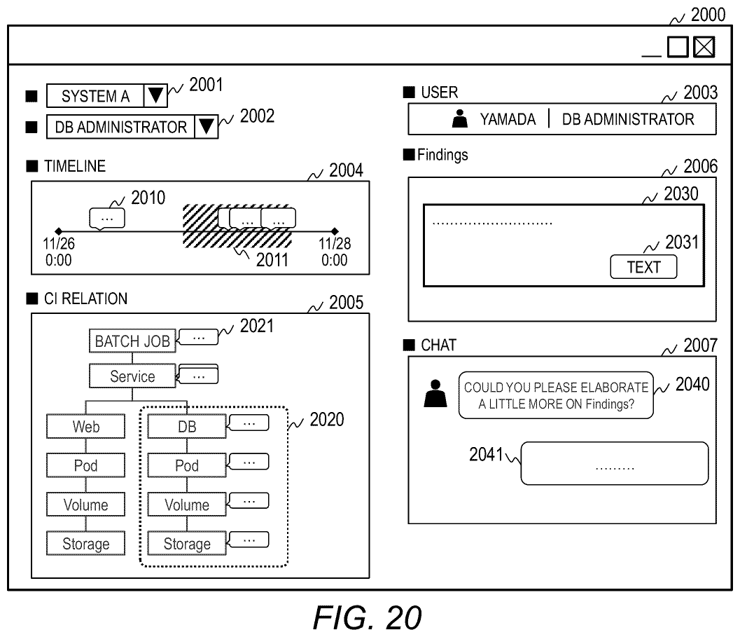

Next, a method of presenting the results of the failure investigation processing is described. FIG. 19 is a flow chart for illustrating an example of information presentation processing to be executed by the management computer 100 in the first embodiment. FIG. 20 is a view for illustrating an example of a screen presented by the management computer 100 in the first embodiment.

When the management computer 100 receives a login operation from the user, the management computer 100 presents a screen 2000 (S701).

Now, the screen 2000 is described. The screen 2000 includes selection fields 2001 and 2002 and display fields 2003, 2004, 2005, 2006, and 2007.

The selection field 2001 is a field for selecting the IT system for which the findings data are to be examined. In the selection field 2001, selectable IT systems are displayed as a drop-down list. The selection field 2002 is a field for selecting the role. In the selection field 2002, selectable roles are displayed as a drop-down list.

The display field 2003 is a field for displaying information on the user performing the operation. In the display field 2003, for example, the user name and the default role are displayed.

The display field 2004 is a field for displaying a time series of pieces of findings data for the IT system. In the display field 2004, an icon 2010 representing a piece of findings data is displayed on a time axis. It is indicated that the piece of findings data was obtained at a time corresponding to a tail of a balloon of the icon 2010. In addition, a rectangle 2011 in the display field 2004 indicates a period of findings data to be referred to.

The display field 2005 is a field for displaying the CIs of the IT system and the relation of the CIs. A dotted line 2020 indicates the scope. Icons 2021 represent a piece of findings data, and is displayed near the corresponding CI.

The display field 2006 is a field for displaying the findings data. A box 2030 for displaying the findings data is displayed in the display field 2006. The box 2030 includes a button 2031. The button 2031 is a button for displaying the observation data text used for generating the findings data corresponding to the box 2030. When the button 2031 is operated, the observation data text is displayed in a dialog box or the like.

The display field 2007 is a field for the user to interact with the management computer 100. When the user inputs a message (question sentence) as a user comment 2040, the management computer 100 generates an answer sentence, and displays the answer sentence as a system answer 2041.

Referring back to FIG. 19, in S701, the information on the user is displayed in the display field 2003, and the default role of the user is set in the selection field 2002.

First, the user sets the name of the IT system in the selection field 2001. The failure investigation support program 120 obtains the name of the IT system through the screen 2000, and identifies the role of the user (S702).

Specifically, the failure investigation support program 120 refers to the user information 131 to search for an entry having the name of the logged-in user set in the user name 501, and obtains the role 503 of the retrieved entry. The failure investigation support program 120 displays the obtained role in the selection field 2002. When a plurality of entries are retrieved, the default role is preferentially displayed.

The user sets a role in the selection field 2002. The failure investigation support program 120 obtains the role of the IT system through the screen 2000 (S703).

Subsequently, the failure investigation support program 120 displays the CI relation of the IT system (S704).

Specifically, the failure investigation support program 120 refers to the CI relation information 133 to display the CI relation in the display field 2005 based on the relation 702 of the entry corresponding to the selected IT system.

Subsequently, the failure investigation support program 120 identifies the scope of the failure investigation for the IT system, and displays the CIs to be investigated (S705). Specifically, the following processing is executed.

(S705-1) The failure investigation support program 120 refers to the scope information 134 to obtain the scope 802 of the entry corresponding to the selected role.

(S705-2) The failure investigation support program 120 refers to the investigation result information 137 to search for an entry having a set of values of the system name 1101, the role 1103, and the scope 1104 matching the set of the name of the selected IT system, the selected role, and the identified scope. The failure investigation support program 120 obtains the CI relation text from the CI relation text 1106 of the retrieved entry.

(S705-3) The failure investigation support program 120 identifies the CIs to be investigated based on the CI relation text. When there are a plurality of scopes, the CIs to be investigated are identified for each of the scopes.

(S705-4) The failure investigation support program 120 highlight-displays the identified CIs in the display field 2005. In FIG. 20, a frame enclosing a group of the CIs is displayed.

Subsequently, the failure investigation support program 120 displays the findings data (S706).

Specifically, the failure investigation support program 120 obtains the output findings data 1110 and the time 1111 of the entry retrieved from the investigation result information 137 in S705, and displays icons representing the findings data in the display fields 2004 and 2005. The failure investigation support program 120 also displays the findings data in the display field 2006. The failure investigation support program 120 may display, in the display field 2006, only the findings data obtained during the period designated in the display field 2004 or the findings data of the CI selected in the display field 2005.

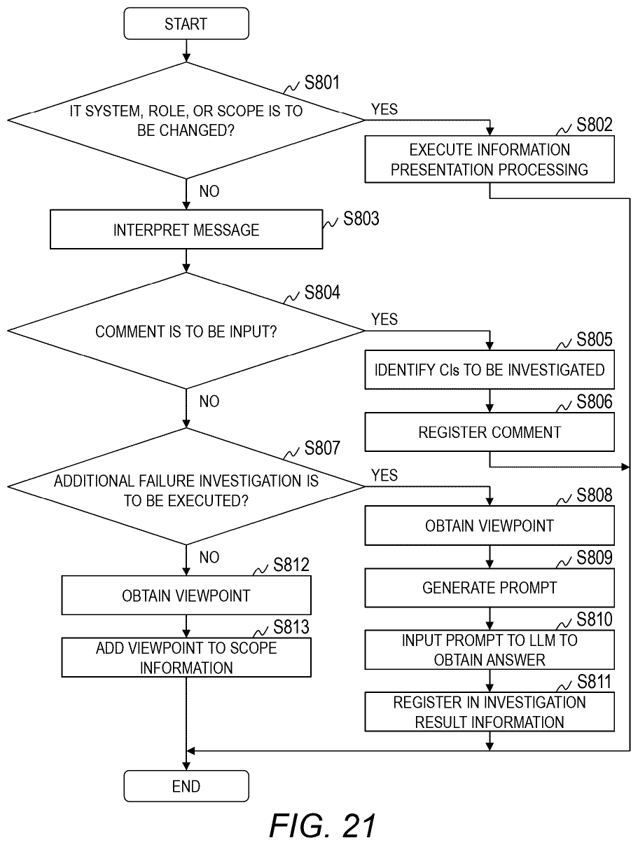

The user can refer to the screen 2000 to perform an operation as the requirement arises. FIG. 21 is a flow chart for illustrating an example of feedback processing to be executed by the management computer 100 in the first embodiment.

When the management computer 100 receives an operation from the user, the management computer 100 starts the feedback processing described below. Examples of the operation include changing of the IT system, the role, or the scope and inputting of a message in the display field 2007.

The failure investigation support program 120 determines whether or not the operation is the changing of any one of the IT system, the role, and the scope (S801).

When the operation is the changing of any one of the IT system, the role, and the scope, the failure investigation support program 120 executes information presentation processing (S802), and ends the feedback processing. Processing details differ depending on the information to be changed. In a case of the changing of the IT system, the processing steps of from S701 to S706 are executed. In a case of the changing of the role, the processing steps of from S703 to S706 are executed. In a case of the changing of the scope, the processing steps of from S704 to S706 are executed.

When the operation is not changing of any one of the IT system, the role, and the scope, the failure investigation support program 120 interprets details of the message (S803). The LLM is used to interpret the details of the message. In the first embodiment, the details of the message are classified into any one of inputting of a comment on the CI, execution of an additional failure investigation, and updating of the viewpoint.

The failure investigation support program 120 determines whether or not the message is for the inputting of a comment on the CI (S804).

When it is determined that the message is for the inputting of a comment on the CI, the failure investigation support program 120 identifies the CIs to be investigated (S805).

Specifically, the failure investigation support program 120 extracts the identification information (for example, instance name) of the CI from the message.

Subsequently, the failure investigation support program 120 registers the comment in the investigation result information 137 (S806), and ends the feedback processing.

Specifically, the failure investigation support program 120 registers the comment in the output findings data 1110 of the entry retrieved from the investigation result information 137 in S705. At this time, the failure investigation support program 120 may generate a prompt that instructs a duplication check, including the comment and the findings data stored in the output findings data 1110, and may input the prompt to the LLM. Thus, it is possible to suppress the recording of duplicate information and to record useful information.

When it is determined that the message is not for the inputting of a comment on the CI, the failure investigation support program 120 determines whether or not the message is for the execution of an additional failure investigation (S807).

When it is determined that the message is for the execution of an additional failure investigation, the failure investigation support program 120 obtains the viewpoint from the message (S808).

Subsequently, the failure investigation support program 120 generates a prompt (S809). Specifically, the following processing is executed.

(S809-1) The failure investigation support program 120 obtains the CI relation text and the observation data text from the entry retrieved from the investigation result information 137 in S705.

(S809-2) The failure investigation support program 120 generates a prompt including the obtained CI relation text and observation data text and having the viewpoint obtained from the message as the instruction.

Subsequently, the failure investigation support program 120 inputs the generated prompt to the LLM and obtains the answer (text) from the LLM (S810).

Subsequently, the failure investigation support program 120 registers the obtained answer in the investigation result information 137 as the findings data (S811), and then ends the feedback processing.

Specifically, the failure investigation support program 120 adds a new entry to the investigation result information 137. The failure investigation support program 120 sets the values of the entry retrieved from the investigation result information 137 in S705 as values of corresponding fields of the added entry in the system name 1101, the scope 1104, the CI relation text 1106, the observation data catalog text 1107, the observation data text 1108, and the input findings data 1109. The failure investigation support program 120 sets the name and the role of the user who has instructed the execution of an additional failure investigation in the user name 1102 and the role 1103 of the added entry. The failure investigation support program 120 sets the viewpoint obtained in S808 in the viewpoint 1105 of the added entry. In addition, the failure investigation support program 120 sets the answer in the output findings data 1110 of the added entry, and sets the time at which the answer was obtained in the time 1111.

When it is determined that the message is not for the execution of an additional failure investigation, the failure investigation support program 120 determines that the message is for the updating of the viewpoint. When the user obtains useful findings as a result of the additionally executed failure investigation, the user adds the viewpoint.

First, the failure investigation support program 120 obtains the viewpoint used in the additional failure investigation from the investigation result information 137 (S812).

Subsequently, the failure investigation support program 120 adds the viewpoint to the scope information 134 (S813), and then ends the feedback processing.

Specifically, the failure investigation support program 120 searches for an entry having the pair of the values of the role 801 and the scope 802 matching a pair of values of the role and the scope in the additional failure investigation, and adds the viewpoint to the viewpoint 803 of the retrieved entry.

A history of operations is recorded in the user operation history information 138.

According to the first embodiment, it is possible to achieve automation of the failure investigation utilizing the LLM without setting complicated rules and developing a program for executing advanced processing. It is also possible to improve the viewability of the failure investigation by summarizing viewpoints for each role. Further, the viewpoint can be added through interaction in the natural language, and hence it is possible to improve accuracy of the failure investigation.

This invention also functions effectively even when roles are not set. In this case, it suffices that the following changes are made.

The management computer 100 does not hold the role order information 135. The user information 131 does not include the role 503. The scope information 134 does not include the role 801. The investigation result information 137 does not include the role 1103.

In the failure investigation processing, the processing steps of S102 and S103 are not executed. In this case, S105 is executed after the processing step of S102, and then the process ends.

The selection field 2002 on the screen 2000 allows the user to select the scope instead of the role. In the information presentation processing, the scope is identified in S702, and the name of the IT system and the scope are obtained in S703.

The present invention is not limited to the above embodiment and includes various modification examples. In addition, for example, the configurations of the above embodiment are described in detail so as to describe the present invention comprehensibly. The present invention is not necessarily limited to the embodiment that is provided with all of the configurations described. In addition, a part of each configuration of the embodiment may be removed, substituted, or added to other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, Python and Java.

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A computer system, comprising:
a processor;
a storage device coupled to the processor; and
a network interface coupled to the processor,
the computer system being coupled to:
an IT system formed of a plurality of elements and configured to execute a service; and
a text generation system configured to generate answer text through use of a natural language processing model in accordance with a prompt that instructs execution of a language processing task,
the computer system holding:
element information for managing observation data obtained from the IT system;
relation information for managing relevance between the plurality of elements; and
scope information that defines a scope representing a range of an investigation in a failure investigation for the IT system,
the scope information storing data in which the scope and a viewpoint of analysis in the failure investigation for the IT system are associated with each other,
wherein the computer system is configured to:
refer to the scope information to select the scope in a case where a failure has occurred in the IT system;
identify at least one of the plurality of elements to be investigated based on the relation information and the selected scope;
obtain the observation data relating to the identified at least one of the plurality of elements from the element information;
generate a first prompt, which includes, as text, the viewpoint corresponding to the selected scope, the identified at least one of the plurality of elements, and the obtained observation data, and which instructs to output findings relating to the failure in the IT system, and input the first prompt to the text generation system; and
obtain the answer text including the findings from the text generation system.

2. The computer system according to claim 1,
wherein the data includes a role being administrative authority of the IT system,
wherein the computer system holds user information for managing the role assigned to a user, and
wherein the computer system is configured to:
generate, in a case of automatically performing the failure investigation for the IT system, the first prompt for each of a plurality of roles and input the first prompt to the text generation system; and
generate, in a case of performing the failure investigation for the IT system in accordance with an instruction received from a user, the first prompt for the role assigned to the user who issued the instruction, and input the first prompt to the text generation system.

3. The computer system according to claim 2, wherein the computer system is configured to:
determine an order of the plurality of roles in the case of automatically performing the failure investigation for the IT system; and
generate and input the first prompt in accordance with the determined order of the plurality of roles.

4. The computer system according to claim 2, wherein the computer system is configured to:
provide an interface for presenting the findings; and
present, in a case where an instruction to present the findings is received from a user, the findings obtained through use of the first prompt for the role assigned to the user who issued the instruction.

5. The computer system according to claim 1, wherein the computer system is configured to generate, in a case where the findings are stored, the first prompt including the findings.

6. The computer system according to claim 1,
wherein the scope included in the data comprises text data, and
wherein the computer system is configured to:
generate a second prompt, which includes text representing the scope and the relation information, and which instructs to identify at least one of the plurality of elements to be investigated; and
input the second prompt to the text generation system to obtain the answer text including the at least one of the plurality of elements to be investigated.

7. The computer system according to claim 1, wherein the computer system is configured to:
generate a third prompt, which includes the observation data relating to the identified at least one of the plurality of elements, and which instructs to generate text of the observation data; and
input the third prompt to the text generation system to obtain the answer text including the text of the observation data.

8. The computer system according to claim 7, wherein the computer system is configured to generate the third prompt after masking some of values included in the observation data.

9. A method of supporting a failure investigation for an IT system, the method being executed by a computer system,
the computer system including:
a processor;
a storage device coupled to the processor; and
a network interface coupled to the processor,
the computer system being coupled to:
the IT system formed of a plurality of elements and configured to execute a service; and
a text generation system configured to generate answer text through use of a natural language processing model in accordance with a prompt that instructs execution of a language processing task,
the computer system holding:
element information for managing observation data obtained from the plurality of elements of the IT system;
relation information for managing relevance between the plurality of elements; and
scope information that defines a scope representing a range of an investigation in the failure investigation for the IT system,
the scope information storing data in which the scope and a viewpoint of analysis in the failure investigation for the IT system are associated with each other,
the method of supporting a failure investigation for an IT system including:
a first step of referring, by the computer system, to the scope information to select the scope in a case where a failure has occurred in the IT system;
a second step of identifying, by the computer system, at least one of the plurality of elements to be investigated based on the relation information and the selected scope;
a third step of obtaining, by the computer system, the observation data relating to the identified at least one of the plurality of elements from the element information;
a fourth step of generating, by the computer system, a first prompt, which includes, as text, the viewpoint corresponding to the selected scope, the identified at least one of the plurality of elements, and the obtained observation data, and which instructs to output findings relating to the failure in the IT system, and inputting the first prompt to the text generation system; and
a fifth step of obtaining, by the computer system, the answer text including the findings from the text generation system.

10. The method of supporting a failure investigation for an IT system according to claim 9,
wherein the data includes a role being administrative authority of the IT system,
wherein the computer system holds user information for managing the role assigned to a user, and
wherein the fourth step includes:
a sixth step of generating, in a case of automatically performing the failure investigation for the IT system, by the computer system, the first prompt for each of a plurality of roles; and
a seventh step of generating, in a case of performing the failure investigation for the IT system in accordance with an instruction received from a user, by the computer system, the first prompt for the role assigned to the user who issued the instruction.

11. The method of supporting a failure investigation for an IT system according to claim 10, wherein the sixth step includes the steps of:
determining, by the computer system, an order of the plurality of roles; and
generating, by the computer system, the first prompt and inputting the first prompt to the text generation system in accordance with the determined order of the plurality of roles.

12. The method of supporting a failure investigation for an IT system according to claim 10, further including the steps of:
providing, by the computer system, an interface for presenting the findings; and
presenting, in a case where an instruction to present the findings is received from a user, by the computer system, the findings obtained through use of the first prompt for the role assigned to the user who issued the instruction.

13. The method of supporting a failure investigation for an IT system according to claim 9,
wherein the scope included in the data comprises text data, and
wherein the fourth the step includes the steps of:
generating, by the computer system, a second prompt, which includes text representing the scope and the relation information, and which instructs to identify at least one of the plurality of elements to be investigated; and
inputting, by the computer system, the second prompt to the text generation system to obtain the answer text including the at least one of the plurality of elements to be investigated.

14. The method of supporting a failure investigation for an IT system according to claim 9, wherein the third step includes:
an eighth step of generating, by the computer system, a third prompt, which includes the observation data relating to the identified at least one of the plurality of elements, and which instructs to generate text of the observation data; and
a ninth step of inputting, by the computer system, the third prompt to the text generation system to obtain the answer text including the text of the observation data.

15. The method of supporting a failure investigation for an IT system according to claim 14, wherein the eighth step includes a step of generating, by the computer system, the third prompt after masking some of values included in the observation data.
